(19) United States
(12) Patent Application Publication
(10) Pub. No.: US 2018/0259118 A1
(43) Pub. Date: Sep. 13, 2018

(54) Adapter Device for Mounting an Optical Device to a Mobile Device

(71) Applicant: Ching Shen, Richmond (CA)

(72) Inventor: Ching Shen, Richmond (CA)

(21) Appl. No.: 15/689,983

(22) Filed: Aug. 29, 2017

Related U.S. Application Data
(60) Provisional application No. 62/469,335, filed on Mar. 9, 2017.

(51) Int. Cl. F16M 13/02; F16B 47/00; F16B 2/08; G02B 7/02; G02B 7/14

(52) U.S. Cl. CPC F16M 13/02; F16B 47/003; G02B 7/14; G02B 7/026; F16B 2/08

(57) ABSTRACT

An adapter device for easily and effectively mounting an optical device to a mobile device. The adapter device includes a housing body, a magnetic attachment mechanism, and a lens-attachment mechanism. The lens-attachment mechanism includes an annular body to receive the optical device. The magnetic attachment mechanism includes a metallic plate and at least one magnet. The metallic plate is attached to the mobile device and the magnet is mounted within the housing body. The metallic plate is positioned adjacent to a front panel of the housing body in order to attach the mobile device to the housing body. The lens-attachment mechanism being mounted to the housing body with the annular body is positioned adjacent to a rear panel of the housing body. The annular body receives and holds the optical device in order to optically couple the mobile device and the optical device.

The current application claims a priority to the U.S. Provisional Patent application Ser. No. 62/469,335 filed on Mar. 9, 2017.

### FIELD OF THE INVENTION

The present invention relates generally to optical device adapters and mobile device accessories. More specifically, the present invention is an adapter device which allows for an optical device to be effectively and easily attached to a mobile device.

### BACKGROUND OF THE INVENTION

Digiscoping is a process of taking photos with a device that has camera through a scope of an optical device. Digiscoping is widely popular in present day where many people implement this process for casual/professional photography. Digiscoping is also used in the medical and science fields. One of the most popular implementation of digiscoping includes mounting a mobile device to an optical device. Mobile devices are popular for digiscoping as they include a relatively advance camera, are easily available, and often include software for manipulating and editing photos. A variety of adapters and devices may be used for digiscoping with mobile device. Unfortunately, these adapters are often highly specialized and are only compatible with certain mobile device and certain optical devices.

It is therefore an objective of the present invention to provide an adapter device for a wider range of mobile devices and optical devices. The present invention includes a first portion with a magnetic surface to receive a mobile device and a second portion to secure onto a wide range of optical device eyepieces. The first portion of the present invention includes a magnetic surface and a magnetic plate. The magnetic plate may be attached to any mobile device, thus making the present invention compatible with any mobile device. The second portion of the present invention includes an adjustable fastener to secure onto an optical device. The user can easily align a camera of a mobile device with the eyepiece of the optical device through the present invention.

### BRIEF DESCRIPTION OF THE DRAWINGS

FIG. 1 is a perspective view of the present invention.

FIG. 2 is an exploded view of the present invention depicted in the FIG. 1.

FIG. 3 is a perspective view of an alternative embodiment of the present invention.

FIG. 4 is an exploded view of the present invention depicted in FIG. 3 with a padded annular band being omitted to show internal components of the present invention.

### DETAIL DESCRIPTIONS OF THE INVENTION

All illustrations of the drawings are for the purpose of describing selected versions of the present invention and are not intended to limit the scope of the present invention.

The present invention is an adapter device for mounting an optical device to a mobile device. In particular, the present invention attaches a mobile device to a lens of an optical device in order to enhance, modify, and or alter the photo or video quality of an internal camera of the mobile device. Type of mobile devices compatible with the present invention includes, but is not limited to, smartphones, laptops, tablets, and other similar devices. In general, the present invention is compatible with any device with a relatively flat rear surface and a camera. Type of optical devices compatible with the present invention includes any optical devices with an optical scope, scope, lens, and other similar features. In general, the present invention is compatible with any type of optical lens with an external housing body 1, in particular a tubular housing body 1.

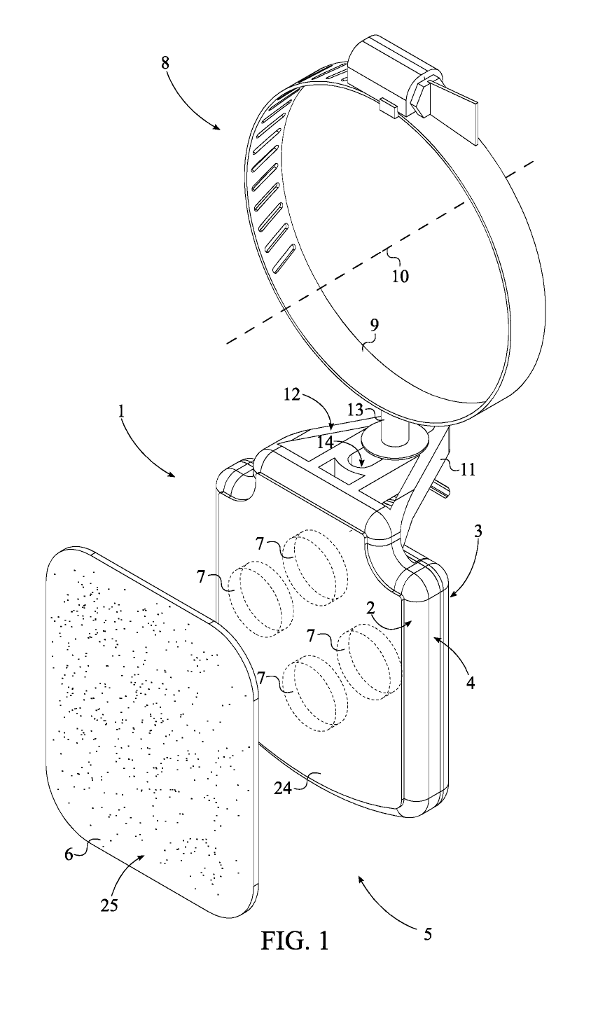

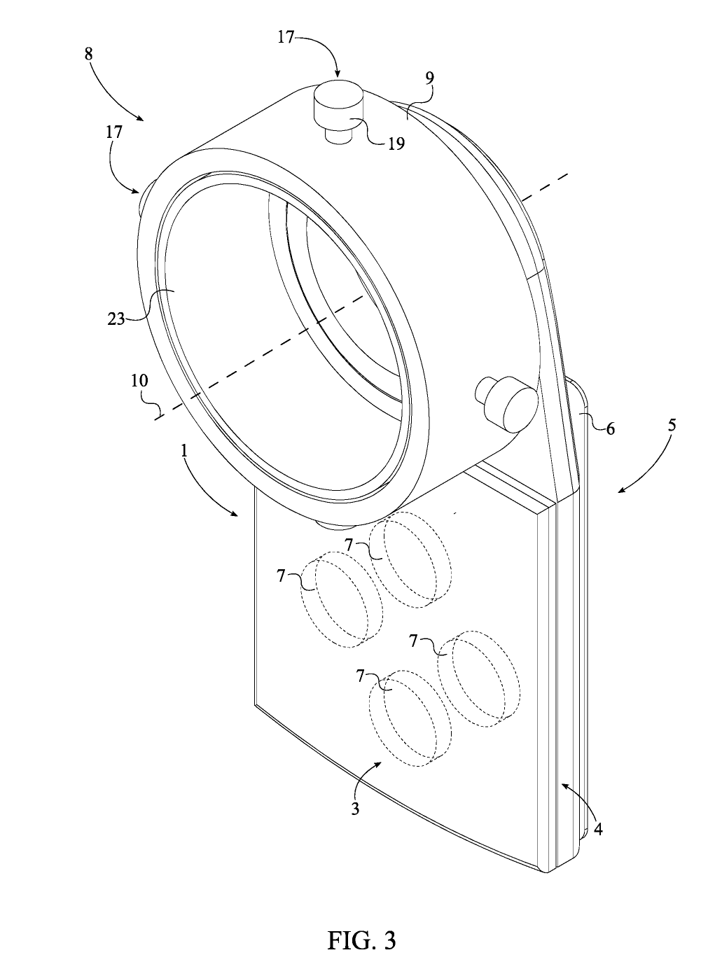

Referring to FIG. 1 and FIG. 3, in its simplest embodiment, the present invention comprises a housing body 1, a magnetic attachment mechanism 5, and a lens-attachment mechanism 8. The housing body 1 acts as the structural element of the present invention and comprises a front panel 2, a rear panel 3, and a lateral sidewall 4. The front panel 2 and the rear panel 3 are each a flat and rectangular extrusion which act as sidewalls. In particular, the front panel 2 and the rear panel 3 are positioned parallel and offset to each other to delineate an internal space. The lateral sidewall 4 connects the front panel 2 and the rear panel 3 as well as enclose the aforementioned internal space. More specifically, the lateral sidewall 4 is perimetrically connected in between the front panel 2 and the rear panel 3. The magnetic attachment mechanism 5 attaches a mobile device to the housing body 1. The magnetic attachment mechanism 5 comprises an at least one magnet 7 and a metallic plate 6. The magnet 7 is a piece of material which exhibits properties of magnetism. The magnet 7 is mounted within the housing body 1, adjacent to the front panel 2, such that a magnetic field is created in front and around the front panel 2. The metallic plate 6 is a flat sheet or strip of ferrous material that is mounted/attached to a mobile device. A variety of means may be used in order to mount/attach the metallic plate 6 to the mobile device including, but not limited to; positioning the metallic plate 6 between the mobile device and a cover case of the mobile device; adhering the metallic plate 6 to the mobile device by glue, tape, or other similar mechanisms. In one embodiment, the metallic plate 6 is adhered to the backing of the mobile device or the interior space of the cover case of said mobile device by an adhesive layer 25. The adhesive layer 25 is positioned adjacent and parallel to the metallic plate 6 and is connected to the metallic plate 6, opposite the housing body 1. Attaching the metallic plate 6 through the adhesive layer 25 semi-permanently attaches the metallic plate 6 to the specific surface.

Through the metallic plate 6 and the magnet, the mobile device can be attached to the front panel 2 of the housing body 1. The metallic plate 6 is sized and shaped complimentary to the front panel 2 to yield a flush mating interface between the metallic plate 6 and the front panel 2. In particular, in order to engage the magnetic attachment mechanism 5, the metallic plate 6 is positioned adjacent to the front panel 2, opposite the rear panel 3, to position the metallic plate 6 within the magnetic field generated by the magnet(s) 7 within the housing body 1. As a result, the metallic plate 6 becomes magnetically attached adjacent to the front panel 2 through the magnet. Pulling the metallic plate 6 and the housing body 1 away from each other will disengage the magnetic attachment mechanism 5. In one embodiment, the present invention further comprises a gripping pad 24. The gripping pad 24 is a piece of material with a high coefficient of friction, such as rubber or other similar material. The gripping pad 24 is positioned adjacent and parallel to the front panel 2. Additionally, the gripping pad 24 is connected to the front panel 2, opposite the rear panel 3. When the metallic plate 6 is pressed against the front panel 2, the gripping pad 24 provides additional friction in between the metallic plate 6 and the front panel 2 to prevent the metallic plate 6 or the mobile device from sliding relative to the housing body 1.

While the magnetic attachment mechanism 5 attaches a mobile device to the housing body 1, the lens-attachment mechanism 8 receives and attaches an optical lens or other similar optical device to the housing body 1. In particular, the lens-attachment mechanism 8 comprises an annular body 9. The annular body 9 is a ring-shaped structure that receives the optical lens. The lens-attachment mechanism 8 is mounted to the housing body 9 with the annular body 9 being positioned adjacent to the rear panel 3, opposite the front panel 2. In order to attach said optical lens to the housing body 1 and the mobile device, the lens-attachment mechanism 8 is mounted to the housing body 1. Additionally, a central axis 10 of the annular body 9 is oriented normal to the front panel 2. When the mobile device and the optical lens are attached to the present invention, this configuration aligns a camera of the mobile device with the optical lens, thus enhancing, modifying, and or altering the optical characteristics of the camera.

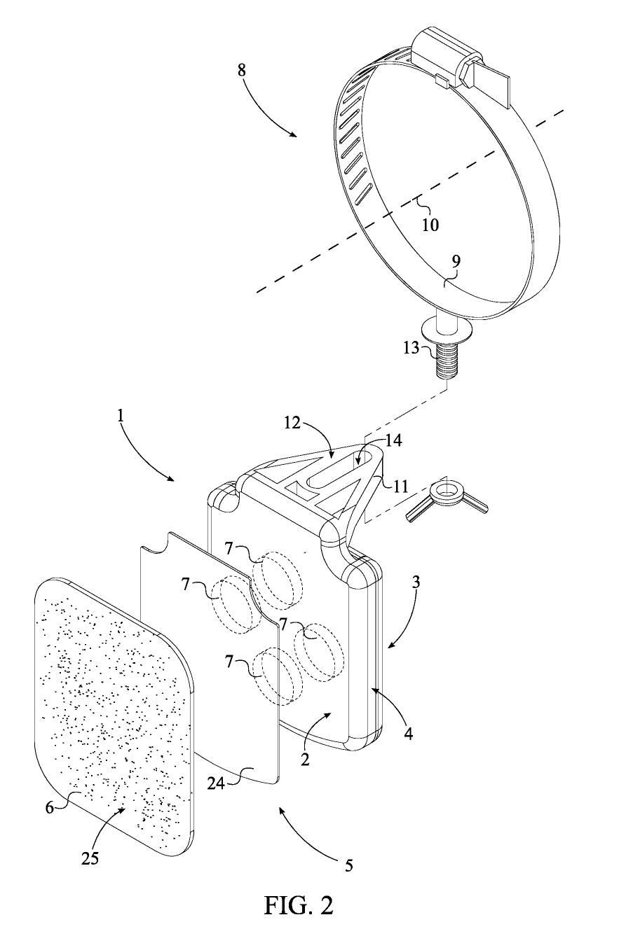

Referring to FIG. 2, in one embodiment of the present invention, the lens-attachment mechanism 8 further comprises a support arm 11, a mounting shaft 13, and a guide slot 14. Additionally, in this embodiment, the annular body 9 is a circumferentially-adjustable hose clamp. The circumferentially-adjustable hose clamp is an annular band with an adjustment mechanism which allows for the constriction and expansion of the annular band. The circumferentially-adjustable hose clamp receives and securely holds the optical lens. To attach the optical lens, the user simply positions the optical lens within the circumferentially-adjustable hose clamp and decreases the overall diameter of the circumferentially-adjustable hose clamp until the optical lens is sufficiently secured within. Because the circumferentially-adjustable hose clamp can be set to a wide range of diameters, the circumferentially-adjustable hose clamp is compatible with a variety of optical lenses of varying sizes. The support arm 11 attaches the circumferentially-adjustable hose clap to the housing body 1. The support arm 11 is connected perpendicular to the rear panel 3, opposite the front panel 2. In particular, the support arm 11 is preferably positioned adjacent to a top portion of the housing body 1. The guide slot 14 and the mounting shaft 13 attach the circumferentially-adjustable hose clamp to the support arm 11, and thus the housing body 1. Additionally, the guide slot 14 and the mounting shaft 13 allow for the circumferentially-adjustable hose clamp to be positioned at a variable distance from the housing body 1. The guide slot 14 traverses normal through the support arm 11 from a top surface 12 of the support arm 11 and extends from the rear panel 3 and along the support arm 11. The mounting shaft 13 is a cylinder shaped component that is radially and externally connected to the circumferentially-adjustable band. The mounting shaft 13 is oriented perpendicular to the support arm 11 and is slidably engaged within and along the guide slot 14. This allows the mounting shaft 13 and the circumferentially-adjustable hose clamp to translate towards and away from the housing body 1. Resultantly providing the user with the ability to adjust the position of the optical lens relative to the housing body 1 and therefore the mobile device attached to the housing body 1. Such minor adjustments ensure that the camera of the mobile device is perfectly aligned with the optical lens, yielding high quality photos and videos.

It is preferred that the mounting shaft 13 contains a threaded portion. The threaded portion traverses through the guided slot and is engaged to an adjustment nut. Loosening the adjustment nut releases the mounting shaft 13 and allows the mounting shaft 13 to slide along the guide slot 14. Tightening the adjustment nut secures the mounting shaft 13 to the support at a specific offset distance from the rear panel 3. Alternative adjustment mechanisms may also be utilized to control and secure the circumferentially-adjustable hose clamp to the support arm 11.

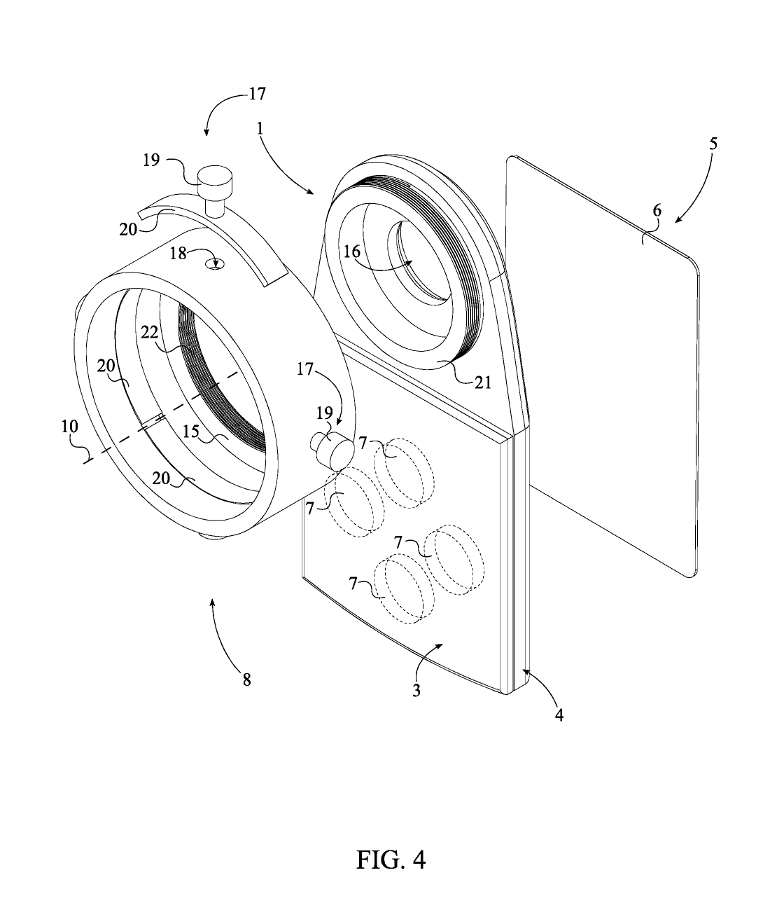

Referring to FIG. 4, in another embodiment of the present invention, the lens-attachment mechanism 8 further comprises a support disk 15, an aperture hole 16, and a plurality of locking mechanisms 17. Additionally, in this embodiment, the annular body 9 is an annular ring. The annular ring is a tubular extrusion with a fixed diameter. The aperture hole 16 traverses through the housing body 1 from the front panel 2 towards the rear panel 3 in order to optically couple the camera of the mobile device with the optical lens through the housing body 1. The support disk 15 acts as a backing for the annular ring and acts as an intermediate support structure in between the housing body 1 and the annular ring. In particular, the support disk 15 is positioned concentric with the aperture hole 16 and is mounted to the rear panel 3, opposite the front panel 2. The annular ring is positioned concentric and adjacent to the support disk 15 and is perimetrically connected to the support disk 15, opposite the housing body 1. This configuration aligns the aperture hole 16, the support disk 15, and the annular ring concentric with each other.

Once the optical lens is positioned within the annular ring, the optical lens is secured in place by the plurality of locking mechanisms 17. More specifically, the plurality of locking mechanisms 17 is radially distributed about the annular ring with each of the plurality of locking mechanisms 17 being mechanically integrated into the annular ring. The plurality of locking mechanisms 17 presses against the optical lens from different sides to adequately secure the optical lens, thus preventing any movement. A variety of mechanisms may be used as the plurality of locking mechanisms 17, although it is preferred that each of the plurality of locking mechanisms 17 comprises a receptive hole 18, an adjustment screw 19, and a semi-annular pad 20. The receptive hole 18 radially traverses through annular ring and receives the adjustment screw 19. In particular, the adjustment screw 19 is threadably engaged within the receptive hole 18 such that clockwise rotation or counter-clockwise rotation will translate the adjustment screw 19 towards or away from the central axis 10. The semi-annular pad 20 engages the optical lens, in particular the external surface of the optical lens. The semi-annular pad 20 distributes pressure about the optical lens in order to prevent damage to the optical lens.

The semi-annular pad 20 is concentrically positioned within the annular ring and is terminally and rotatably connected to the adjustment screw 19. Resultantly, the adjustment screw 19 is free to rotate without rotating the semi-annular pad 20.

Referring to FIG. 4, the lens-attachment mechanism 8 further comprises a first tubular mount 21 and a second tubular mount 22 in order to easily mount the support disk 15 to the housing body 1. The first tubular mount 21 is connected to the housing body 1 and the second tubular mount 22 is connected to the support disk 15 and the annular ring. Additionally, the first tubular mount 21 and the second tubular mount 22 are sized complimentary to interlock with each other, thus allowing the user to easy attach and detach the optical lens to and from the housing body 1 through the first tubular mount 21 and the second tubular mount 22. More specifically, the first tubular mount 21 is positioned concentric with the aperture hole 16 and is connected to the rear panel 3, opposite the front panel 2. The second tubular mount 22 has a greater diameter than the first tubular mount 21 in order to be able to sleeve the first tubular mount 21. The second tubular mount 22 is positioned concentric and adjacent to the support disk 15. Additionally, the second tubular mount 22 is connected to the support disk 15, opposite the annular ring. When attached, the second tubular mount 22 is concentrically positioned with the first tubular mount 21, wherein the first tubular mount 21 is threadably attached to within the second tubular mount 22. This allows for the easy attachment of different sized annular rings in order to expand the compatibility of the present invention to a variety of optical lens designs, shapes, and sizes. In other embodiments of the present invention, the annular ring may be a tube with a square cross-section, a pentagon cross-section, and other similar shapes.

In the preferred embodiment of the present invention, the at least one magnet 7 comprises a plurality of magnets. The plurality of magnets is distributed about the front panel 2 in order to generate a stronger and larger magnetic field about the housing body 1, in particular the front panel 2. Each magnet 7 is pressed in between the front panel 2 and the rear panel 3 in order to prevent unnecessary movement. Resultantly, the force with which the metallic plate 6 is held against the front panel 2 is increased, thus ensuring that the mobile device is securely held to the housing body 1. Additionally, increasing the number of magnets allows for a larger and heavier mobile device to be utilized with the present invention. In one embodiment, a portion of the rear panel 3 is removable in order to provide the user with access to the plurality of magnets for maintenance and manufacturing processes.

Referring to FIG. 3, the present invention may also comprise a padded annular band 23. The padded annular band 23 is a strip of relatively soft material, such as rubber and felt, that is positioned in between the annular body 9 and the optical lens in order to prevent damage and unnecessary wear and tear to the optical lens. Prior to inserting the optical lens into the annular body 9, the padded annular band 23 is concentrically positioned within the annular body 9 and is adjacently attached to the annular body 9. the padded annular band 23 may be attached to the annular body 9 through double-sided take, hook-and-loop fasteners, and other similar means.

Although the invention has been explained in relation to its preferred embodiment, it is to be understood that many other possible modifications and variations can be made without departing from the spirit and scope of the invention as hereinafter claimed.

What is claimed is:

1. An adapter device for mounting an optical device to a mobile device comprises:
a housing body;
a magnetic attachment mechanism;
a lens-attachment mechanism;
the lens-attachment mechanism comprises an annular body;
the magnetic attachment mechanism comprises a metallic plate and an at least one magnet;
the housing body comprises a front panel, a rear panel, and a lateral sidewall;
the front panel and the rear panel being positioned parallel and offset to each other;
the lateral sidewall being perimetrically connected in between the front panel and the rear panel;
the at least one magnet being mounted within the housing body, adjacent to the front panel;
the metallic plate being positioned adjacent to the front panel, opposite the rear panel;
the metallic plate being magnetically attached adjacent to the front panel through the at least one magnet;
the annular body being positioned adjacent to the rear panel, opposite the front panel;
the lens-attachment mechanism being mounted to the housing body; and
a central axis of the annular body being oriented normal to the front panel; the lens-attachment mechanism being mounted to the housing body.

2. The adapter device for mounting an optical device to a mobile device as claimed in claim 1 comprises:
the lens-attachment mechanism further comprises a support arm, a mounting shaft, and a guide slot;
the annular body being a circumferentially-adjustable hose clamp;
the support arm being connected perpendicular to the rear panel, opposite front panel;
the guide slot traversing normal through the support arm from a top surface of the support arm;
the guide slot extending from the rear panel and along the support arm;
the mounting shaft being radially and externally connected to the circumferentially-adjustable band;
the central axis being positioned offset to the lateral sidewall;
the mounting shaft being oriented perpendicular to the support arm; and
the mounting shaft being slidably engaged within and along the guide slot.

3. The adapter device for mounting an optical device to a mobile device as claimed in claim 1 comprises:
a padded annular band;
the padded annular band being concentrically positioned within the annular body; and
the padded annular band being adjacently attached to the annular body.

4. The adapter device for mounting an optical device to a mobile device as claimed in claim 1 comprises:
the lens-attachment mechanism further comprises a support disk, an aperture hole, and a plurality of locking mechanisms;
the annular body being an annular ring;
the aperture hole normally traversing through the housing body from the front panel towards the rear panel;
the support disk being positioned concentric with the aperture hole;
the support disk being mounted to the rear panel, opposite the front panel;
the annular ring being positioned concentric and adjacent to the support disk;
the annular ring being perimetrically connected to the support disk, opposite the housing body;
the plurality of locking mechanisms being radially distributed about the annular ring; and
each of the plurality of locking mechanisms being mechanically integrated into the annular ring.

5. The adapter device for mounting an optical device to a mobile device as claimed in claim 4 comprises:
each of the plurality of locking mechanisms comprises a receptive hole, an adjustment screw, and a semi-annular pad;
the receptive hole radially traversing through the annular ring;
the adjustment screw being threadably engaged within the receptive hole;
the semi-annular pad being concentrically positioned within the annular ring; and
the semi-annular pad being terminally and rotatably connected to the adjustment screw.

6. The adapter device for mounting an optical device to a mobile device as claimed in claim 4 comprises:
the lens-attachment mechanism further comprises a first tubular mount and a second tubular mount;
the first tubular mount being positioned concentric with the aperture hole;
the first tubular mount being adjacently connected to the rear panel, opposite the front panel;
the second tubular mount being positioned concentric and adjacent to the support disk;
the second tubular mount being connected to the support disk, opposite the annular ring;
the second tubular mount being concentrically positioned with the first tubular mount; and
the first tubular mount being threadably attached within the second tubular mount.

7. The adapter device for mounting an optical device to a mobile device as claimed in claim 1 comprises:
the at least one magnet being distributed about the front panel; and
the at least one magnet being pressed in between the front panel and the rear panel.

8. The adapter device for mounting an optical device to a mobile device as claimed in claim 1 comprises:
a gripping pad;
the gripping pad being positioned adjacent and parallel to the front panel; and
the gripping pad being connected to the front panel, opposite the rear panel.

9. The adapter device for mounting an optical device to a mobile device as claimed in claim 1 comprises:
an adhesive layer;
the adhesive layer being positioned adjacent and parallel to the metallic plate; and
the adhesive layer being connected to the metallic plate, opposite the housing body.

10. An adapter device for mounting an optical device to a mobile device comprises:
a housing body;
a magnetic attachment mechanism;
a lens-attachment mechanism;
the lens-attachment mechanism comprises an annular body;
the magnetic attachment mechanism comprises a metallic plate and an at least one magnet;
the housing body comprises a front panel, a rear panel, and a lateral sidewall;
the lens-attachment mechanism further comprises a support arm, a mounting shaft, and a guide slot;
the front panel and the rear panel being positioned parallel and offset to each other;
the lateral sidewall being perimetrically connected in between the front panel and the rear panel;
the at least one magnet being mounted within the housing body, adjacent to the front panel;
the metallic plate being positioned adjacent to the front panel, opposite the rear panel;
the metallic plate being magnetically attached adjacent to the front panel through the at least one magnet;
the annular body being positioned adjacent to the rear panel, opposite the front panel;
the lens-attachment mechanism being mounted to the housing body;
a central axis of the annular body being oriented normal to the front panel; the lens-attachment mechanism being mounted to the housing body;
the annular body being a circumferentially-adjustable hose clamp;
the support arm being connected perpendicular to the rear panel, opposite front panel;
the guide slot traversing normal through the support arm from a top surface of the support arm;
the guide slot extending from the rear panel and along the support arm;
the mounting shaft being radially and externally connected to the circumferentially-adjustable band;
the central axis being positioned offset to the lateral sidewall;
the mounting shaft being oriented perpendicular to the support arm; and
the mounting shaft being slidably engaged within and along the guide slot.

11. The adapter device for mounting an optical device to a mobile device as claimed in claim 1 comprises:
a padded annular band;
the padded annular band being concentrically positioned within the annular body; and
the padded annular band being adjacently attached to the annular body.

12. The adapter device for mounting an optical device to a mobile device as claimed in claim 10 comprises:
the at least one magnet being distributed about the front panel; and
the at least one magnet being pressed in between the front panel and the rear panel.

13. The adapter device for mounting an optical device to a mobile device as claimed in claim 10 comprises:
a gripping pad;
the gripping pad being positioned adjacent and parallel to the front panel; and
the gripping pad being connected to the front panel, opposite the rear panel.

14. The adapter device for mounting an optical device to a mobile device as claimed in claim 10 comprises:
an adhesive layer;
the adhesive layer being positioned adjacent and parallel to the metallic plate; and
the adhesive layer being connected to the metallic plate, opposite the housing body.

15. An adapter device for mounting an optical device to a mobile device comprises:
a housing body;
a magnetic attachment mechanism;
a lens-attachment mechanism;
the lens-attachment mechanism comprises an annular body;
the magnetic attachment mechanism comprises a metallic plate and an at least one magnet;
the housing body comprises a front panel, a rear panel, and a lateral sidewall;
the lens-attachment mechanism further comprises a support disk, an aperture hole, and a plurality of locking mechanisms;
the front panel and the rear panel being positioned parallel and offset to each other;
the lateral sidewall being perimetrically connected in between the front panel and the rear panel;
the at least one magnet being mounted within the housing body, adjacent to the front panel;
the metallic plate being positioned adjacent to the front panel, opposite the rear panel;
the metallic plate being magnetically attached adjacent to the front panel through the at least one magnet;
the annular body being positioned adjacent to the rear panel, opposite the front panel;
the lens-attachment mechanism being mounted to the housing body;
a central axis of the annular body being oriented normal to the front panel; the lens-attachment mechanism being mounted to the housing body;
the annular body being an annular ring;
the aperture hole normally traversing through the housing body from the front panel towards the rear panel;
the support disk being positioned concentric with the aperture hole;
the support disk being mounted to the rear panel, opposite the front panel;
the annular ring being positioned concentric and adjacent to the support disk;
the annular ring being perimetrically connected to the support disk, opposite the housing body;
the plurality of locking mechanisms being radially distributed about the annular ring; and
each of the plurality of locking mechanisms being mechanically integrated into the annular ring.

16. The adapter device for mounting an optical device to a mobile device as claimed in claim 15 comprises:
a padded annular band;
the padded annular band being concentrically positioned within the annular body; and
the padded annular band being adjacently attached to the annular body.

17. The adapter device for mounting an optical device to a mobile device as claimed in claim 15 comprises:
each of the plurality of locking mechanisms comprises a receptive hole, an adjustment screw, and a semi-annular pad;
the receptive hole radially traversing through the annular ring;
the adjustment screw being threadably engaged within the receptive hole;
the semi-annular pad being concentrically positioned within the annular ring; and
the semi-annular pad being terminally and rotatably connected to the adjustment screw.

18. The adapter device for mounting an optical device to a mobile device as claimed in claim 15 comprises:
the lens-attachment mechanism further comprises a first tubular mount and a second tubular mount;
the first tubular mount being positioned concentric with the aperture hole;
the first tubular mount being adjacently connected to the rear panel, opposite the front panel;
the second tubular mount being positioned concentric and adjacent to the support disk;
the second tubular mount being connected to the support disk, opposite the annular ring;
the second tubular mount being concentrically positioned with the first tubular mount; and
the first tubular mount being threadably attached within the second tubular mount.

19. The adapter device for mounting an optical device to a mobile device as claimed in claim 15 comprises:
the at least one magnet being distributed about the front panel; and
the at least one magnet being pressed in between the front panel and the rear panel.

20. The adapter device for mounting an optical device to a mobile device as claimed in claim 15 comprises:
a gripping pad;
the gripping pad being positioned adjacent and parallel to the front panel; and
the gripping pad being connected to the front panel, opposite the rear panel.

21. The adapter device for mounting an optical device to a mobile device as claimed in claim 15 comprises:
an adhesive layer;
the adhesive layer being positioned adjacent and parallel to the metallic plate; and
the adhesive layer being connected to the metallic plate, opposite the housing body.
